(19) United States
(12) Patent Application Publication
(10) Pub. No.: US 2025/0350191 A1
(43) Pub. Date: Nov. 13, 2025

(54) SYSTEMS AND METHODS FOR BUCK-BOOST RIPPLE REDUCTION USING BIASED QUANTIZER

(71) Applicant: Cirrus Logic International Semiconductor Ltd., Edinburgh (GB)

(72) Inventors: Siddharth MARU, Austin, TX (US); Markos KOSEOGLOU, Austin, TX (US)

(73) Assignee: Cirrus Logic International Semiconductor Ltd., Edinburgh (GB)

(21) Appl. No.: 19/052,554

(22) Filed: Feb. 13, 2025

Related U.S. Application Data
(60) Provisional application No. 63/644,696, filed on May 9, 2024.

(51) Int. Cl. H02M 1/14; H02M 1/088; H02M 3/158

(52) U.S. Cl. CPC H02M 1/14; H02M 1/088; H02M 3/1582

(57) ABSTRACT

A system may include a modulator configured to generate switching signals for a switching circuit based on a control variable, the modulator comprising a quantizer configured to, for a range of values of the control variable within a predetermined difference from a boundary of the control variable between a first operational mode and a second operational mode of the switching circuit, bias the control variable by a bias amount to increase a probability of operating the switching circuit in the first operational mode for a switching cycle if a previous switching cycle of the switching circuit was in the second operational mode; and increase a probability of operating the switching circuit in the second operational mode for the switching cycle if the previous switching cycle of the switching circuit was in the first operational mode.

### RELATED APPLICATION

The present disclosure claims priority to U.S. Provisional Patent Application No. 63/644,696, filed May 9, 2024, which is incorporated by reference herein in its entirety.

### FIELD OF DISCLOSURE

The present disclosure relates in general to circuits for electronic devices, including without limitation personal audio devices such as wireless telephones and media players, and more specifically, systems and methods for minimizing buck-boost ripple in a buck-boost power converter.

### BACKGROUND

Personal audio devices, including wireless telephones, such as mobile/cellular telephones, cordless telephones, mp3 players, and other consumer audio devices, are in widespread use. Such personal audio devices may include circuitry for driving a pair of headphones, one or more speakers, haptic actuators, camera stabilization motors, and/or other loads. Such circuitry often includes a driver including a power amplifier for driving an output signal to such loads. Oftentimes, a power converter may be used to provide a supply voltage to a power amplifier in order to amplify a signal driven to speakers, headphones, other transducers, or other loads. A switching power converter is a type of electronic circuit that converts a source of power from one direct current (DC) voltage level to another DC voltage level. Examples of such switching DC-DC converters include but are not limited to a boost converter, a buck converter, a buck-boost converter, an inverting buck-boost converter, and other types of switching DC-DC converters. Thus, using a power converter, a DC voltage such as that provided by a battery may be converted to another DC voltage used to power the power amplifier. A power converter may be used to provide supply voltage rails to one or more components in a device. A power converter may also be used in other applications besides driving audio transducers, such as driving haptic actuators or other electrical or electronic loads. Further, a power converter may also be used in charging a battery from a source of electrical energy (e.g., an AC-to-DC adapter), oftentimes as part of a power management integrated circuit (PMIC).

In applications in which the output and input voltages of a power converter may be expected to be close to one another, a four-switch buck-boost converter is often used. Use of a four-switch buck-boost converter may enable operating in a buck-boost mode when output voltage is close to input voltage and shifting to buck or boost modes when the output voltage is sufficiently separated from the input to improve efficiency.

The operation in buck-boost mode and transition into and out of buck-boost mode from the buck and boost modes may cause non-linearities in operation that may lead to ripple on the output voltage. In addition, a smooth transition into and out of buck-boost mode may be critical to minimize discontinuity on the output voltage. Further, continuous operation in the buck-boost mode at all times may not be an option due to negative impacts on efficiency.

### SUMMARY

In accordance with the teachings of the present disclosure, one or more disadvantages and problems associated with operation of power converters may be reduced or eliminated.

In accordance with embodiments of the present disclosure, a system may include a modulator configured to generate switching signals for a switching circuit based on a control variable, the modulator comprising a quantizer configured to, for a range of values of the control variable within a predetermined difference from a boundary of the control variable between a first operational mode and a second operational mode of the switching circuit, bias the control variable by a bias amount to increase a probability of operating the switching circuit in the first operational mode for a switching cycle if a previous switching cycle of the switching circuit was in the second operational mode; and increase a probability of operating the switching circuit in the second operational mode for the switching cycle if the previous switching cycle of the switching circuit was in the first operational mode.

In accordance with these and other embodiments of the present disclosure, a method may include, in a modulator configured to generate switching signals for a switching circuit on a control variable, for a range of values of the control variable within a predetermined difference from a boundary of the control variable between a first operational mode and a second operational mode of the switching circuit, biasing the control variable by a bias amount to increase a probability of operating the switching circuit in the first operational mode for a switching cycle if a previous switching cycle of the switching circuit was in the second operational mode; and increase a probability of operating the switching circuit in the second operational mode for the switching cycle if the previous switching cycle of the switching circuit was in the first operational mode.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a circuit diagram of selected components of an example buck-boost power converter, in accordance with embodiments of the present disclosure;

FIG. 2 illustrates a block diagram of selected components of an example system for driving a load using a power converter, in accordance with embodiments of the present disclosure;

FIGS. 3A-3C illustrate operation of the example buck-boost power converter depicted in FIG. 1, in accordance with embodiments of the present disclosure;

FIG. 4 illustrates example carrier wave signals for use by a modulator to generate switch control signals, in accordance with embodiments of the present disclosure;

FIG. 5 illustrates an example quantization scheme, in accordance with embodiments of the present disclosure;

FIG. 6A illustrates an example waveform of a power inductor current over four switching cycles of a power converter within a buck-boost dead zone, in absence of the quantizer biasing, leading to two consecutive boost cycles followed by two consecutive buck cycles, in accordance with embodiments of the present disclosure; and

FIG. 6B illustrates an example waveform of a power inductor current IL over four switching cycles of a power converter with the buck-boost dead zone, with quantizer biasing, leading to alternating buck and boost cycles, in accordance with embodiments of the present disclosure.

### DETAILED DESCRIPTION

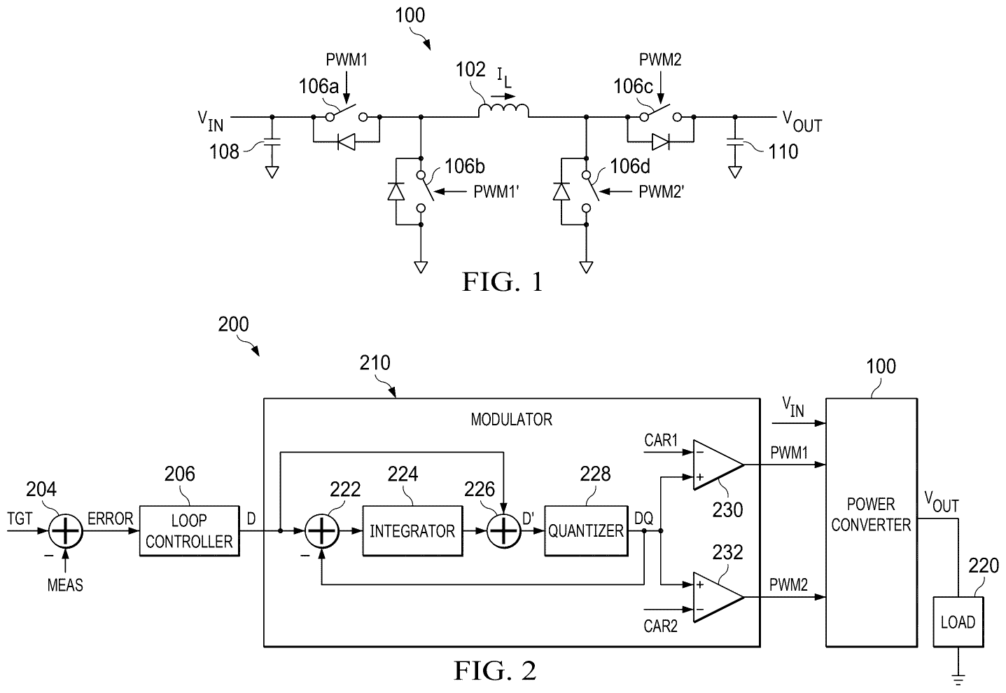

FIG. 1 illustrates a circuit diagram of selected components of an example buck-boost power converter 100, in accordance with embodiments of the present disclosure. As shown in FIG. 1, buck-boost power converter 100 may receive an input voltage V_{IN} on an input capacitor 108 and have an output configured to generate an output voltage V_{OUT} on an output capacitor 110 based on switching signals PWM1 and PWM2, which may comprise pulse-width modulation signals. Buck-boost power converter 100 may also include a power inductor 102. In addition, buck-boost power converter 100 may include a plurality of switches 106a, 106b, 106c, and 106d, wherein switch 106a is coupled between the input and a first terminal of power inductor 102, switch 106b is coupled between the first terminal of power inductor 102 and a ground voltage, switch 106c is coupled between the output and a second terminal of power inductor 102, and switch 106d is coupled between second first terminal of power inductor 102 and the ground voltage. In operation, switch 106a may be controlled by control signal PWM1, switch 106b may be controlled by 15 a complement of control signal PWM1 (e.g., PWM1′), switch 106c may be controlled by control signal PWM2, and switch 106d may be controlled by a complement of control signal PWM2 (e.g., PWM2′) in order to drive a power inductor current I_{L} through power inductor 102 to regulate output voltage V_{OUT} to a desired target voltage.

FIG. 2 illustrates a block diagram of selected components of an example system 200 for driving a load 220 using power converter 100, in accordance with embodiments of the present disclosure. As shown in FIG. 2, system 200 may include power converter 100, a signal combiner 204, a loop controller 206, a modulator 210, and a load 220.

Signal combiner 204 may comprise any suitable system, device, or apparatus configured to calculate an error signal ERROR equal to the difference between a target signal TGT and a measured feedback signal MEAS. Target signal TGT may represent a target or desired value for any physical quantity within system 200, including without limitation output voltage V_{OUT}. Likewise, measured feedback signal MEAS may comprise a measured value of such physical quantity (e.g., a measured value for output voltage V_{OUT}). For purposes of clarity and exposition, circuitry for measuring measured feedback signal MEAS is not shown in FIG. 2; however system 200 may include such circuitry and those of skill in the art would readily have knowledge of how to implement such circuitry to measure measured feedback signal MEAS.

Loop controller 206 may comprise any system, device, or apparatus configured to implement a control loop to regulate measured feedback signal MEAS to track target signal TGT. For example, based on error signal ERROR, loop controller 206 may generate a reference signal D. Such reference signal D may represent, for example, a commanded duty cycle for power converter 100 to cause regulation of measured feedback signal MEAS to track target signal TGT. In some embodiments, reference signal D may vary between values of 0 and 2, where the range of values 0 to 1 correspond to duty cycles of 0% and 100%, respectively, of buck operation of power converter 100 and the range of values 1 to 2 correspond to duty cycles of 0% and 100%, respectively, of boost operation of power converter 100. Loop controller 206 may be implemented with a proportional (P) controller, proportional-integral (PI) controller, proportional-differential (PD) controller, proportional-integral-differential (PID) controller, or any other suitable controller.

Modulator 210 may comprise any suitable system, device, or apparatus configured to receive reference signal D, and generate switching signals PWM1 and PWM2 for controlling switching of switches of power converter 100. In some embodiments, modulator 210 may comprise a pulse-width modulator. As shown in FIG. 2, in some embodiments, modulator 210 may be implemented as a delta-sigma modulator comprising a signal combiner 222, an integrator 224, a signal combiner 226, a quantizer 228, a comparator 230, and a comparator 232.

Signal combiner 222 may comprise any suitable system, device, or apparatus configured to calculate an error signal equal to the difference between reference signal D and a quantized reference signal DQ output by quantizer 228.

Integrator 224 may comprise any suitable system, device, or apparatus configured to integrate the error signal in order to accumulate the error signal over time.

Signal combiner 226 may comprise any suitable system, device, or apparatus configured to sum reference signal D with the accumulated error signal to generate an error adjusted reference signal D′.

Quantizer 228 may comprise any system, device, or apparatus configured to generate a quantized reference signal DQ based on adjusted reference signal D′. In some embodiments, such quantization may be performed to avoid generation of control signals PWM1 and PWM2 having impractically short switching times, and thus may constrain possible values of quantized reference signal DQ to avoid such impractically short switching times, with the quantization error being compensated for over time by the accumulated integration of error by integrator 224. For example, for values of adjusted reference signal D′ below a buck limit DbuckMax (e.g., 0.9) and above a boost limit DboostMin (e.g., 1.1), quantizer 228 may simply pass the value of adjusted reference signal D′ as quantized reference signal DQ. However, for values between buck limit DbuckMax and boost limit DboostMin (e.g., between 0.9 and 1.1), a buck-boost “dead zone” may exist to where quantized reference signal DQ is forced to buck limit DbuckMax if adjusted reference signal D′ is between buck limit DbuckMax (e.g., 0.9) and a buck-boost boundary Dbound (e.g., 1.0) and forced to boost limit DboostMin if adjusted reference signal D′ is between buck-boost boundary Dbound (e.g., 1.0) and boost limit DboostMin (e.g., 1.1).

Further, as described in greater detail below, in order to minimize ripple on output voltage V_{OUT}, quantizer 228 may also be configured to, in certain situations, force buck operation of power converter 100 when adjusted reference signal D′ is above buck-boost boundary Dbound (e.g., 1.0) and force boost operation of power converter 100 when adjusted reference signal D′ is below buck-boost boundary Dbound (e.g., 1.0).

Comparator 230 may comprise any system, device, or apparatus configured to compare quantized reference signal DQ to a carrier signal CAR1 and generate control signal PWM1 based on such comparison, as described in greater detail below.

Similarly, comparator 232 may comprise any system, device, or apparatus configured to compare quantized reference signal DQ to a carrier signal CAR2 and generate control signal PWM2 based on such comparison, as described in greater detail below.

Load 220 may include any appropriate electrical or electronic load that may be powered from power converter 202, including without limitation a rechargeable battery.

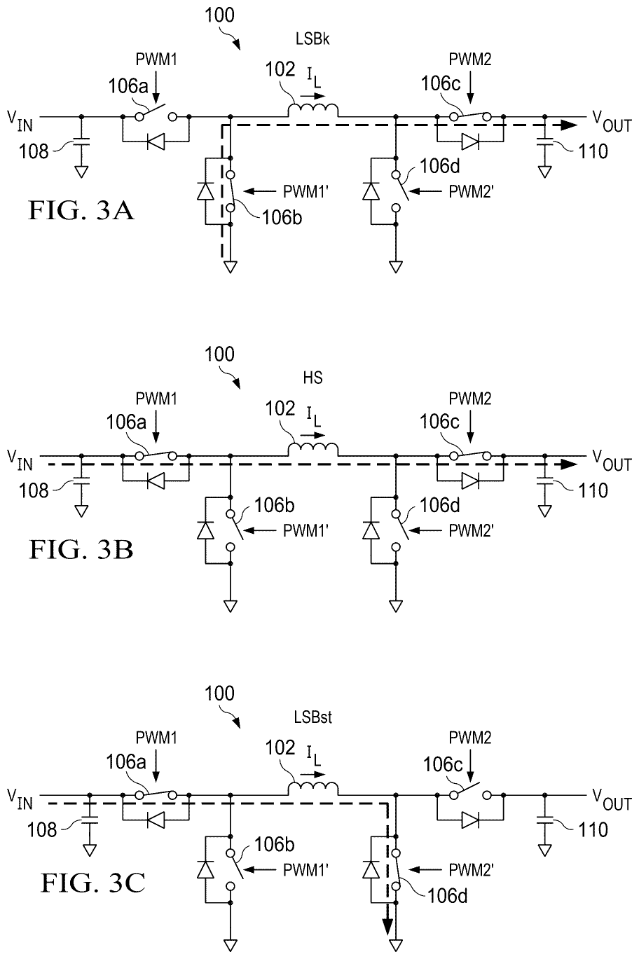

In operation, switches 106 may be controlled by modulator 210 to regulate output voltage V_{OUT} to a desired target voltage. As shown in FIGS. 3A-3C, operation of power converter 100 may include cyclic, periodic commutation of switches 106 among a low-side buck state LSBk (shown in FIG. 3A), a high-side state HS (shown in FIG. 3B), and a low-side boost-state LSBst (shown in FIG. 3C).

For example, as shown in FIG. 3A, in low-side buck state LSBk, switches 106b and 106c may be activated (and switches 106a and 106d deactivated), such that current flows from ground voltage to the output of power converter 100 through switch 106b, power inductor 102, and switch 106c. As another example, as shown in FIG. 3B, in high-side buck state HS, switches 106a and 106c may be activated (and switches 106b and 106d deactivated), such that current flows from the input to the output of power converter 100 through switch 106a, power inductor 102, and switch 106c. As a further example, as shown in FIG. 3C, in low-side boost state LSBst, switches 106a and 106d may be activated (and switches 106b and 106c deactivated), such that current flows from the input of power converter 100 to ground voltage through switch 106a, power inductor 102, and switch 106d.

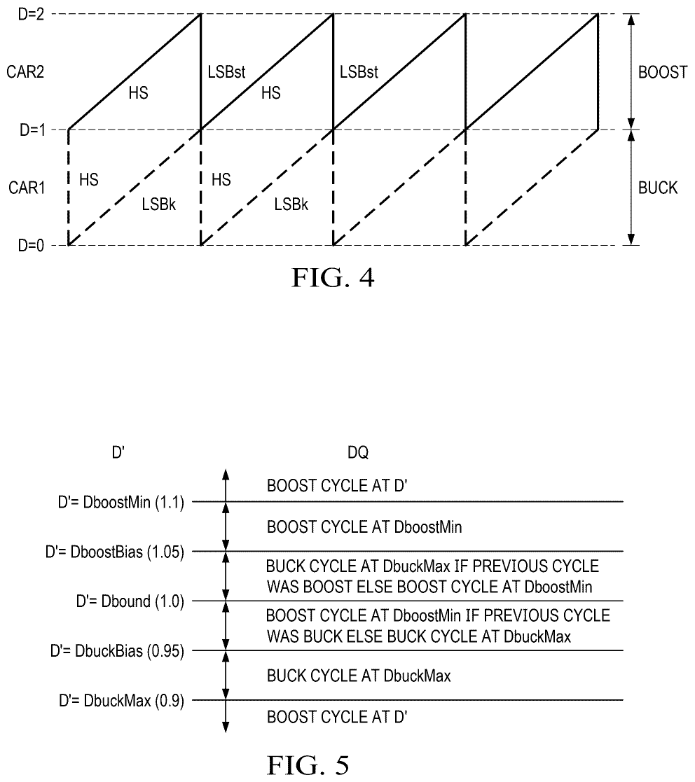

FIG. 4 illustrates example carrier wave signals CAR1 and CAR2 for use by modulator 210 to generate switch control signals PWM1 and PWM2, in accordance with embodiments of the present disclosure. Although FIG. 4 shows carrier signals CAR1 and CAR2 as sawtooth waves, it is understood that carrier signals CAR1 and CAR2 may comprise any suitable waveform (e.g., triangle wave). As depicted in FIG. 4, modulator 210 may compare reference signal D to each of CAR1 and CAR2 and based on the comparison, generate appropriate control signals PWM1 and PWM2 to cause switches 106 of power converter 100 to switch into a particular switch state. For example, when reference signal D is less than carrier signal CAR1 and carrier signal CAR2, modulator 210 may generate control signals PWM1 and PWM2 to cause switches 106 of power converter 100 to operate in low-side buck state LSBk. As another example, when reference signal D is greater than carrier signal CAR1 and less than carrier signal CAR2, modulator 210 may generate control signals PWM1 and PWM2 to cause switches 106 of power converter 100 to operate in high-side state HS. As a further example, when reference signal D is greater than carrier signal CAR1 and carrier signal CAR2, modulator 210 may generate control signals PWM1 and PWM2 to cause switches 106 of power converter 100 to operate in low-side boost state LSBst.

As mentioned above, quantizer 228 may be “biased” in certain situations to force buck operation of power converter 100 when adjusted reference signal D′ is above buck-boost boundary Dbound (and would otherwise operate in boost operation with an unbiased, conventional quantizer) or to force boost operation of power converter 100 when adjusted reference signal D′ is below buck-boost boundary Dbound (and would otherwise operate in buck operation with an unbiased, conventional quantizer). To that end, FIG. 5 illustrates an example quantization scheme that may be implemented by quantizer 228, in accordance with embodiments of the present disclosure.

As shown in FIG. 5, for values of adjusted reference signal D′ equal to or less than buck limit DbuckMax (e.g., 0.9), quantizer 228 may generate quantized reference signal DQ equal to adjusted reference signal D′, causing a buck switching cycle for power converter 100. For values of adjusted reference signal D′ greater than buck limit DbuckMax (e.g., 0.9), but lesser than a buck-bias threshold DbuckBias (e.g., 0.95), quantizer 228 may generate quantized reference signal DQ equal to buck limit DbuckMax (e.g., 0.9), causing a buck switching cycle for power converter 100.

For values of adjusted reference signal D′ greater than or equal to buck-bias threshold DbuckBias (e.g., 0.95), but less than buck-boost boundary (e.g., 1.0), quantizer 228 may: (a) if the previous cycle of power converter 100 was a buck cycle, generate quantized reference signal DQ equal to boost limit DboostMin (e.g., 1.1), causing a boost switching cycle for power converter 100; and (b) if the previous cycle of power converter 100 was a boost cycle, generate quantized reference signal DQ equal to buck limit DbuckMax (e.g., 0.9), causing a buck switching cycle for power converter 100.

Similarly, for values of adjusted reference signal D′ greater than or equal to buck-boost boundary (e.g., 1.0), but less than or equal to a boost-bias threshold DboostBias (e.g., 1.05), quantizer 228 may: (a) if the previous cycle of power converter 100 was a boost cycle, generate quantized reference signal DQ equal to buck limit DbuckMax (e.g., 0.9), causing a buck switching cycle for power converter 100; and (b) if the previous cycle of power converter 100 was a buck cycle, generate quantized reference signal DQ equal to boost limit DboostMin (e.g., 1.1), causing a boost switching cycle for power converter 100.

Stated another way, for values of adjusted reference signal D′ greater than or equal to buck-bias threshold DbuckBias (e.g., 0.95) but lesser than boost-bias threshold DboostBias (e.g., 1.05), quantizer 228 may toggle quantized reference signal DQ between buck limit DbuckMax (e.g., 0.9) and boost limit DboostMin (e.g., 1.1), to create alternating buck and boost switching cycles for power converter 100.

Further, for values of adjusted reference signal D′ greater than boost-bias threshold DboostBias (e.g., 1.05), but lesser than or equal to boost limit DboostMin (e.g., 1.1), quantizer 228 may generate quantized reference signal DQ equal to buck limit DboostMin (e.g., 1.1), causing a boost switching cycle for power converter 100. Also, for values of adjusted reference signal D′ greater than or equal to boost limit DboostMin (e.g., 1.1), quantizer 228 may generate quantized reference signal DQ equal to adjusted reference signal D′, causing a boost switching cycle for power converter 100.

The foregoing quantization scheme applies a fixed/deterministic value to generate quantized reference signal DQ. However, in some embodiments, quantizer 228 may apply a quantization scheme in which the value of quantized reference signal DQ is random when adjusted reference signal D′ is greater than buck-bias threshold DbuckBias (e.g., 0.95) but lesser than boost-bias threshold DboostBias (e.g., 1.05)

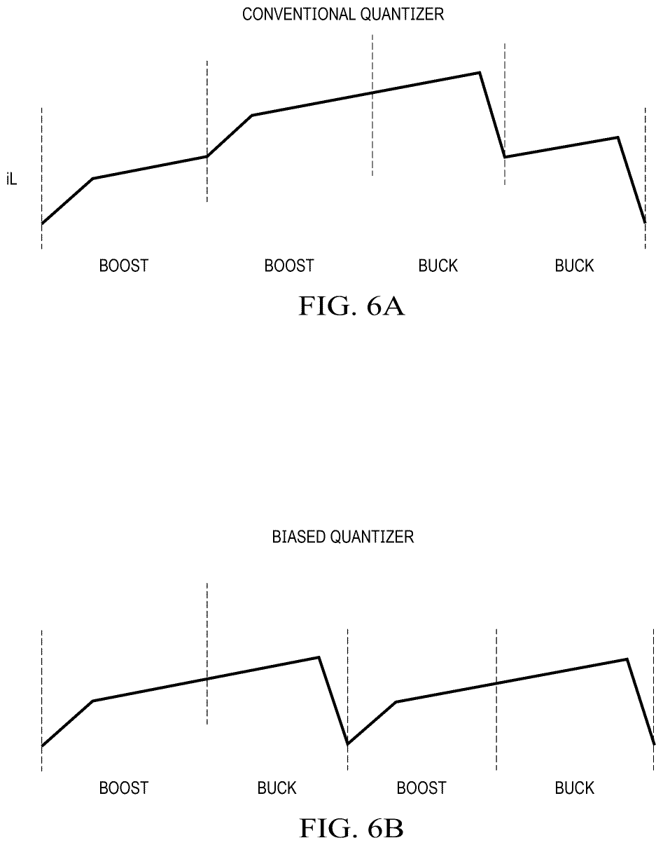

To illustrate the motivation for such biasing of quantizer 228, reference is made to FIGS. 6A and 6B.

FIG. 6A illustrates an example waveform of power inductor current IL over four switching cycles of power converter 100 within the buck-boost dead zone (and in particular the region in which adjusted reference signal D′ is between buck-bias threshold DbuckBias and boost-bias threshold DboostBias), in absence of the biasing described above, leading to two consecutive boost cycles followed by two consecutive buck cycles, in accordance with embodiments of the present disclosure. Under such operation, a “conventional” quantizer may correct for cycle-to-cycle charge error and regulate the average of output voltage V_{OUT} to its target voltage level. However, as seen from FIG. 6A, such operation may add high-frequency noise and successive buck or boost cycles may lead to substantial variation in power inductor current I_{L}.

FIG. 6B illustrates an example waveform of power inductor current I_{L} over four switching cycles of power converter 100 within the buck-boost dead zone (and in particular the region in which adjusted reference signal D′ is between buck-bias threshold DbuckBias and boost-bias threshold DboostBias), with the biasing described above, leading to alternating buck and boost cycles, in accordance with embodiments of the present disclosure. As compared to FIG. 6A, FIG. 6B demonstrates that the biased quantizer 228 may lead to an improved volt-second balance for power inductor 102 and a lower ripple in power inductor current I_{L}. Such improved volt-second balance and minimized ripple in power inductor current I_{L} may lead to lower ripple in output voltage V_{OUT}.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112 (f) unless the words “means for” or “step for” are explicitly used in the particular claim.

What is claimed is:

1. A system comprising:
a modulator configured to generate switching signals for a switching circuit based on a control variable, the modulator comprising a quantizer configured to, for a range of values of the control variable within a predetermined difference from a boundary of the control variable between a first operational mode and a second operational mode of the switching circuit, bias the control variable by a bias amount to:
increase a probability of operating the switching circuit in the first operational mode for a switching cycle if a previous switching cycle of the switching circuit was in the second operational mode; and
increase a probability of operating the switching circuit in the second operational mode for the switching cycle if the previous switching cycle of the switching circuit was in the first operational mode.

2. The system of claim 1, wherein the bias amount is a fixed value.

3. The system of claim 1, wherein the bias amount is a random value.

4. The system of claim 1, wherein the switching circuit is a buck-boost power converter.

5. The system of claim 4, wherein the switching circuit is a four-switch buck-boost power converter.

6. The system of claim 4, wherein:
the first operational mode is a boost mode of the four-switch buck-boost power converter; and
the second operational mode is a buck mode of the four-switch buck-boost power converter.

7. The system of claim 1, wherein:
increasing the probability of operating the switching circuit in the first operational mode for the switching cycle if the previous switching cycle of the switching circuit was in the second operational mode comprises operating the switching circuit in the first operational mode for the switching cycle if the previous switching cycle of the switching circuit was in the second operational mode; and
increasing the probability of operating the switching circuit in the second operational mode for the switching cycle if the previous switching cycle of the switching circuit was in the first operational mode comprises operating the switching circuit in the first operational mode for the switching cycle if the previous switching cycle of the switching circuit was in the second operational mode.

8. The system of claim 1, wherein the control variable is representative of a duty cycle of the switching circuit.

9. The system of claim 8, wherein:
the switching circuit is a buck-boost power converter;
the control variable may vary between a minimum value and a maximum value;
the minimum value and the boundary correspond to a minimum buck duty cycle and a maximum buck duty cycle, respectively, for buck operation of the buck-boost power converter; and
the boundary and the maximum value correspond to a minimum boost duty cycle and a maximum boost duty cycle, respectively, for boost operation of the buck-boost power converter.

10. The system of claim 9, wherein the boundary is at approximately a midpoint between the minimum value and the maximum value.

11. The system of claim 1, wherein the quantizer is further configured to constrain possible values of the control variable to avoid impractically short switching times for switches of the switch circuit.

12. A method comprising, in a modulator configured to generate switching signals for a switching circuit on a control variable, for a range of values of the control variable within a predetermined difference from a boundary of the control variable between a first operational mode and a second operational mode of the switching circuit, biasing the control variable by a bias amount to:
increase a probability of operating the switching circuit in the first operational mode for a switching cycle if a previous switching cycle of the switching circuit was in the second operational mode; and
increase a probability of operating the switching circuit in the second operational mode for the switching cycle if the previous switching cycle of the switching circuit was in the first operational mode.

13. The method of claim 12, wherein the bias amount is a fixed value.

14. The method of claim 12, wherein the bias amount is a random value.

15. The method of claim 12, wherein the switching circuit is a buck-boost power converter.

16. The method of claim 15, wherein the switching circuit is a four-switch buck-boost power converter.

17. The method of claim 16, wherein:
the first operational mode is a boost mode of the four-switch buck-boost power converter; and
the second operational mode is a buck mode of the four-switch buck-boost power converter.

18. The method of claim 12, wherein:
increasing the probability of operating the switching circuit in the first operational mode for the switching cycle if the previous switching cycle of the switching circuit was in the second operational mode comprises operating the switching circuit in the first operational mode for the switching cycle if the previous switching cycle of the switching circuit was in the second operational mode; and
increasing the probability of operating the switching circuit in the second operational mode for the switching cycle if the previous switching cycle of the switching circuit was in the first operational mode comprises operating the switching circuit in the first operational mode for the switching cycle if the previous switching cycle of the switching circuit was in the second operational mode.

19. The method of claim 12, wherein the control variable is representative of a duty cycle of the switching circuit.

20. The method of claim 19, wherein:
the switching circuit is a buck-boost power converter;
the control variable varies between a minimum value and a maximum value;
the minimum value and the boundary correspond to a minimum buck duty cycle and a maximum buck duty cycle, respectively, for buck operation of the buck-boost power converter; and
the boundary and the maximum value correspond to a minimum boost duty cycle and a maximum boost duty cycle, respectively, for boost operation of the buck-boost power converter.

21. The method of claim 20, wherein the boundary is at approximately a midpoint between the minimum value and the maximum value.

22. The method of claim 12, further comprising constraining possible values of the control variable to avoid impractically short switching times for switches of the switch circuit.
